(19) United States
(12) Patent Application Publication
(10) Pub. No.: US 2015/0235151 A1
(43) Pub. Date: Aug. 20, 2015

(54) Workflow Tracking System

(71) Applicant: Bear River Associates, Inc., Oakland, CA (US)

(72) Inventors: Jason Winshell, San Francisco, CA (US); Benjamin Flaumenhaft, Cambridge, MA (US)

(73) Assignee: Bear River Associates, Inc., San Ramon, CA (US)

(21) Appl. No.: 14/184,607

(22) Filed: Feb. 19, 2014

(51) Int. Cl. G06Q 10/06

(52) U.S. Cl. CPC G06Q 10/0633

(57) ABSTRACT

A method of operating a data processing system to monitor conforming events generated by an event generating system is disclosed. The method includes storing lists of workflow definitions and active workflow instances. Each workflow definition includes a plurality of phase definitions, each phase definition includes a list of event types that start and terminate that phase. Each active workflow instance conforms to one of the workflow definitions and includes a list of active phase instances for that active workflow instance. Conforming events are processed by terminating an active phase instance if the conforming event corresponds to an event that terminates that active phase instance, by starting a new active phase instance if the conforming event corresponds to an event that starts a phase corresponding to one of the workflow instances, and by recording the conforming event and all active phase instances that were started or terminated by the conforming event.

### BACKGROUND

Many business models can be described in terms of “workflows”. A workflow can be viewed as a process that accomplishes some overall goal. Typically, the workflow is divided into a plurality of phases. Each phase accomplishes some defined sub-task within the workflow. A workflow has a first phase that is commenced in response to some event. The phase terminates when another event occurs. An event that ends one phase can also commence another phase. The workflow terminates when there are no more active phases associated with that workflow. At any given time, there may multiple instances of workflows operative within a business entity. The individual instances may relate to the same type of workflow or to different types of workflows. In the following discussion, the term “workflow” will be used to denote the definition of a particular type of workflow. The workflow describes the various phases without reference to a real object or process that is currently being processed by the workflow. An instance of a workflow denotes the workflow applied to a specific example of that workflow.

A workflow can be more easily understood with reference to a specific example. Consider a workflow that describes the delivery of a package from a sender to a final recipient. The workflow consists of all the phases of the delivery process starting with the request for package pickup from the sender and ending when the package is either delivered to the final recipient or returned to the sender because it could not be delivered. The processing of each package corresponds to an instance of the workflow in question.

The request to pickup the package is an event that starts a first phase of a corresponding workflow. When the request is received, a data processing system associated with the delivery organization initiates an instance of the package delivery workflow and assigns it an identification number. The events associated with the package are tracked and reported with this identification number, which, in turn, identifies the specific instance of the workflow. When an event causes a workflow instance to be created, it also starts a phase in that workflow. For example, the shipping details could be entered into a database and a pickup courier designated. The first phase could end when the data is entered. The ending of the first phase triggers a second phase which ends when the courier picks up the package. The second phase triggers yet a third phase which ends when the courier delivers the package to a shipping terminal, and so on.

In addition to “back-to-back” phases in which one phase ends and another begins, multiple phases can be defined in which phases can overlap other phases. For example, an instance of a first phase could be started and terminated during the time that an instance of another phase remains active. In addition, multiple phases could be started or terminated in response to a single event.

It should also be noted that whether or not a particular phase is started or terminated could also depend on a condition that is not included in the event that is being examined to determine if the phase should be started or terminated. Providing a mechanism for considering such predicates prior to starting or ending a phase presents additional challenges.

At any given time, a business entity could have thousands of instances of workflows in process. In addition, there can be a number of different workflows that are active at the same time. For example, different workflows could be defined for foreign shipments as opposed to domestic shipments. In the above example, each package that is to be delivered is in a separate workflow instance that must be tracked. Typically, the organization involved with the workflow has some form of tracking system that receives data describing events related to various instances of the workflow. In the case of the package delivery system discussed above, the arrival of the package at various way-points on the route is noted and reported to the central data processing system that tracks all of the packages in the system. The data processing system is typically a large complex database system that is not easily altered to provide data and reports different from the reports that were envisioned at the time the data processing system was programmed. In addition, any changes to the system require the intervention of programmers with very specialized knowledge, and hence, a manager who wishes to examine the operation of some aspect of the underlying workflow cannot easily get custom reports that provide the information that the manager seeks without a large amount of extraneous data.

The underlying tracking system is optimized for the tracking function. First, the current location of the package must be ascertainable and the expected time of delivery must be determinable. In the case of package delivery workflow, the sender, recipient, and delivery service all need to be able to access this information.

However, managers need to be able to perform statistical analysis of the workflow process in question to determine bottlenecks and performance measures of individual phases. The business needs to determine if the workflow is executing as designed. Complex workflows may operate in practice in a manner that is significantly different than the manner the designer envisioned. Periodically, the workflow may need to be modified in view of various delays or other problems that were not anticipated in the original design. Workflows usually involve actions by people whose performance varies from individual to individual. Hence, identifying phases and/or people who overperform or underperform are of value to the organization responsible for the workflow. While the data produced by the tracking system can be analyzed to provide this additional information, the process of defining a program that sifts through the output of the tracking system to provide the desired analysis is typically outside the technical programming expertise of the managers of the business entity. Hence, the data analysis process has a significant barrier that inhibits managers from asking new questions about the performance of the workflows being tracked.

In addition, a number of different monitoring “consoles” may be of value in a large organization. Different managers can have much different needs in terms of monitoring different workflows. Providing a mechanism that allows different real-time monitors of the underlying workflows without requiring the intervention of a specialized programmer to build each console presents significant challenges.

### SUMMARY

The present invention includes a method of operating a data processing system to monitor conforming events generated by an event generating system. The method includes storing lists of workflow definitions and active workflow instances. Each workflow definition includes a plurality of phase definitions, each phase definition includes a list of event types that start and terminate that phase. Each active workflow instance conforms to one of the workflow definitions and includes a list of active phase instances for that active workflow instance. For each conforming event received, the data processing system processes the conforming event by terminating an active phase instance if the conforming event corresponds to an event that terminates that active phase instance, by starting a new active phase instance if the conforming event corresponds to an event that starts a phase corresponding to one of the workflow instances, and by recording the conforming event and all active phase instances that were started or terminated by the conforming event.

In one aspect of the invention, the data processing system terminates an active workflow instance if no active phase instance corresponds to the active workflow instance after any active phase instance of the workflow has been started in response to the received conforming event and records the termination of the active workflow instance.

In another aspect of the invention, the data processing system starts an active workflow instance corresponding to one of the workflow definitions if no active workflow instance corresponds to the received conforming event, and the received conforming event has an event type that is included in one of the lists of event types that starts a phase of that workflow definition.

In yet another aspect of the invention, the conforming events are characterized by a time stamp associated with each conforming event, the time stamp defining a time corresponding to the conforming event. The data processing system also includes an event queue into which each received conforming event is placed prior to being processed, the conforming events in the queue include an oldest queue conforming event. The oldest queue conforming event is the conforming event in the queue with the oldest time stamp. The data processing system selects the oldest queue conforming event for processing before others of the conforming events in the queue.

In another aspect of the invention, the recorded conforming events are characterized by an oldest recorded conforming event, the oldest recorded conforming event having a time stamp that is older than all other recorded conforming events. The data processing system compares the time stamp on the oldest queue conforming event to the time stamp of the oldest recorded conforming event. The data processing system moves the oldest recorded conforming event back to the queue if the time stamp of the oldest recorded conforming event is earlier than the time stamp of the oldest queue conforming event. Any active phase instances that were terminated in response to the oldest queue conforming event are moved to the list of active phase instances, and any active phase instances that were started in response to the oldest queue conforming event are removed from the list of active phase instances when the oldest recorded conforming event is moved back to the queue. In addition, any active workflow instances that were terminated in response to the oldest queue conforming event are moved to the list of active workflow instances, and any active workflow instances that were started in response to the oldest queue conforming event are removed from the list of active workflow instances when the oldest recorded conforming event is moved back to the queue.

In another aspect of the invention, one of the phase definitions includes a list of call-back conforming events, each call-back conforming event includes an event type and a corresponding function to be called if that event type is included in one of the received conforming events. The data processing system calls the call-back function prior to terminating any active phase instances associated with the received conforming event.

In a still further aspect of the invention, the data processing system further includes a user interface that allows a user to define one of the workflow definitions and phases corresponding thereto, the user interface includes a display that displays a list of possible conforming events that can be included in the list of event types that start and/or terminate a phase in the workflow definition. The user interface also allows the user to name each workflow and phase with a name chosen by the user.

In yet another aspect of the invention, one of the active workflow definitions includes a maximum duration. The data processing system terminates an active workflow instance corresponding to that workflow definition if the active workflow instance has been active for longer than the maximum duration.

### BRIEF DESCRIPTION OF THE DRAWINGS

FIG. 1 illustrates a data processing system according to the present invention.

FIG. 2 illustrates the processing of an external event by a supervisor program.

FIG. 3 illustrates a user interface according to one embodiment of the present invention.

### DETAILED DESCRIPTION

While the present invention can be more easily understood in terms of a specific type of business such as the package delivery business discussed above, the present invention can be applied to any business that provides a string of events that are characterized by three attributes. First, each event must have a unique identification code associated with that event that can be used to tie that event to an instance of a workflow. In the package delivery example, the identification code is typically the package tracking number. Second, each event must also have an event type. In the package delivery example, an event might be “arrived at processing terminal”, “package information received”, and so on. Third, each event must have a time stamp that determines when the event occurred. The time can be the beginning of the event, the end of the event, or any other well defined point in the event processing that can be used to order the events chronologically. In addition, there is optionally a fourth attribute that will be referred to as the event descriptive data. The event descriptive data includes notes on the event or other data that is not used by the present invention, but may be of value in the final processing of the data extracted by the present invention. For example, in the package delivery example, the event descriptive data could identify the driver who operated the delivery vehicle. Events that have the first three attributes will be referred to as conforming events in the following discussion.

The system that generates the conforming events will be referred to as the event generating system. It should be noted that any overall goal can, typically, be described in terms of a number of different workflows. The event generating system may be organized with one of these workflows in mind. The present invention, in general, defines a different workflow for describing the overall task. For example, the present invention may combine phases of the event generating system workflow into a single phase in the workflow of the present invention, or the present invention's workflow may leave out phases of the event generating system workflow, since those phases are not of interest to the model being examined in the workflow of the present invention. To avoid confusion, the term workflow in the following discussion will be used to describe a workflow defined in the present invention in contrast to any workflows that are defined in the event generating system.

For the purposes of this discussion, a workflow is defined to be a process having a plurality of phases that accomplishes some overall goal. A phase is a sub-task within the workflow that is characterized by a starting event and an ending event and accomplishes some part of the overall goal. A workflow is a model of a process. The workflow is not attached to any specific object or goal. When a specific object or goal is to be processed using the workflow, an instance of that workflow is created and attached to the specific object or process. An instance of a workflow starts when a first phase associated with that workflow is attached to some specific object. The instance of the workflow terminates when the last phase associated with that instance terminates. For example, a workflow might define the phases in delivering a package from the request for pickup to the actual handoff to the recipient. When a specific package enters the system, an instance of the workflow is created in the data processing system and assigned to the tracking number of that package. In general, there are multiple instances of a workflow that are active at any given time, but only one workflow.

A workflow will be said to be defined over a set of events, if the phases of that workflow begin and end in response to events in that set of events. An instance of a workflow begins when one of the events initiates one of the phases of the workflow. An instance of a workflow terminates in response to an event when there are no more active phases in that instance after processing that event. The present invention assumes that a system that generates the underlying set of events already exists and that a list of the relevant events generated by event generating system is known.

The present invention includes a method for operating a data processing system to process the events to provide data that allows the processes to be modeled in terms of workflows that are different from those in the event generating system. For the purposes of the present discussion it will be assumed that the data processing system is separate from the data processing system in the event generating system; however, embodiments in which the present invention is integrated into the data processing system of the event generating system can also be constructed.

In the present invention, a data processing system receives events that trigger or terminate phases of a workflow. The data processing system has a library of workflows. At any given time, there may be multiple instances of any of these defined workflows in progress. The data processing system stores and manages these instances of workflows, and starts and stops those instances. The manner in which the library of workflows is created will be discussed in more detail below.

One class of events will be referred to as “external events”. An external event is an event that is not generated by the data processing system itself. Instances of phases within a workflow are started and terminated in response to external events. For example, a user could enter the shipping details for a new shipment that is to be tracked, which, in turn, causes the data processing system to start a new instance of a package delivery workflow for that package and assign the tracking number of that instance to the workflow. In contrast, an “internal event” is an event that is generated within the data processing system in response to some other event occurring. Internal events will be discussed in more detail below.

In one aspect of the present invention, a workflow is defined by a name and a list of the phases associated with that workflow. Each phase is defined by two lists and the corresponding name. The first list includes the event types that cause the phase to start. The second list includes the event types that cause the phase to terminate. In this case, the phase itself contains no code.

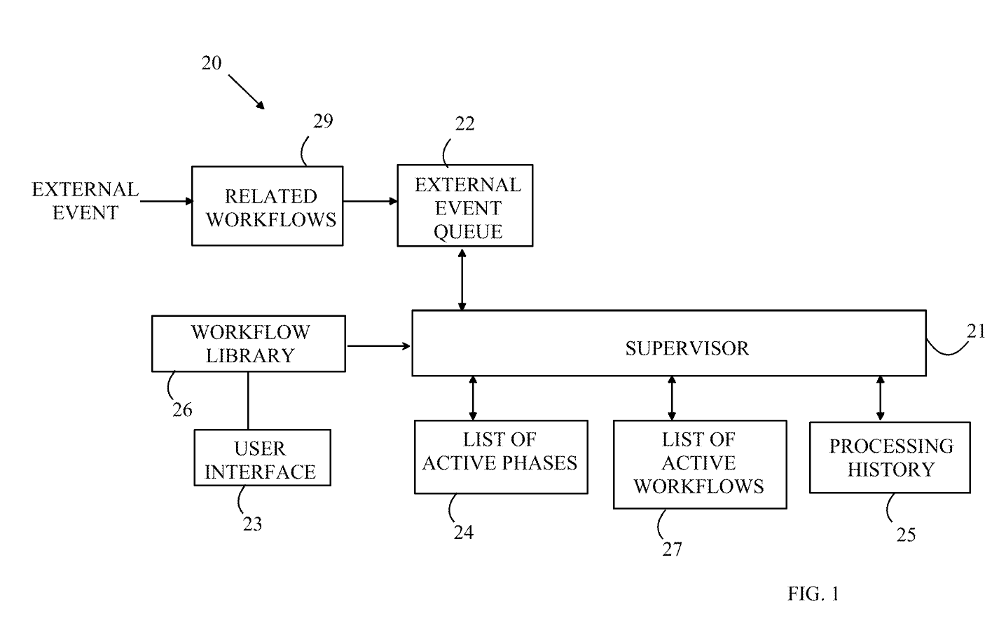

Refer now to FIG. 1, which illustrates a data processing system according to the present invention. Data processing system 20 receives external events from the event generating system and stores those events in an external event queue 22. The external events are processed by a supervisor program 21 that processes the events in an order specified by the time stamps associated with each event, the oldest events being processed first. At any given time, there are typically a plurality of instances of workflows that are active. These active workflow instances are stored in a list 27. The active instances of the phases associated with these active workflow instances are stored in a list 24. For the purposes of this discussion, an active workflow instance is defined to be an instance of a workflow definition in workflow library 26 that has been started in response to a received conforming event but has not yet been terminated. Similarly, an active phase instance is defined to be an instance of a phase defined for an active workflow instance that has been started in response to a received conforming event but has not yet been terminated.

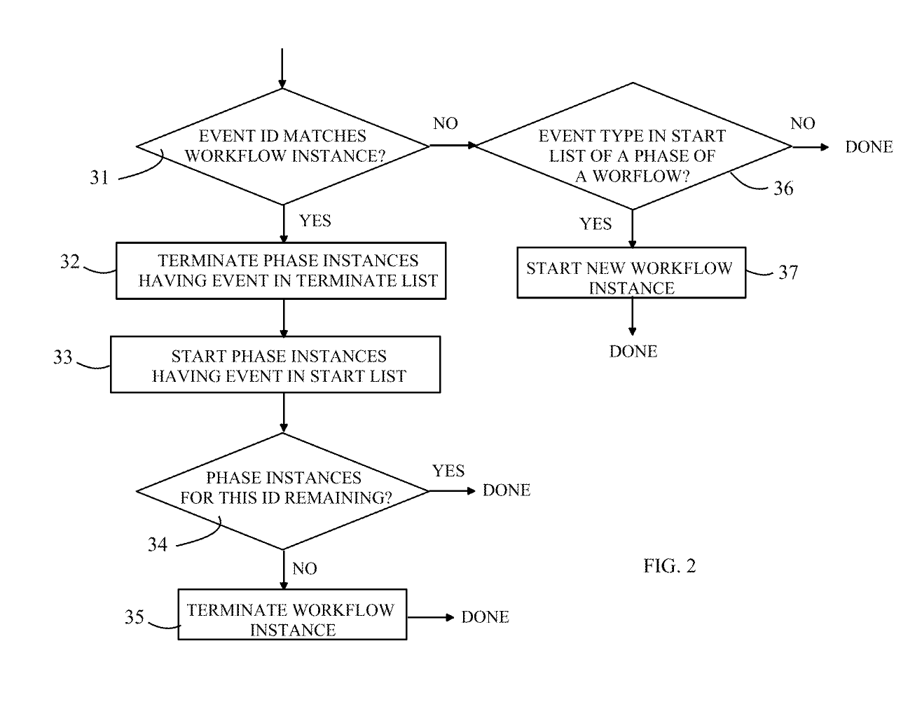

Refer now to FIG. 2, which illustrates one embodiment of the processing of an external event by supervisor program 21. Each time an external event is processed, supervisor program 21 compares the identification code associated with that event with the identification codes of the active workflow instances as shown at 31. The event identification code in the event either matches the idenification code associated with an existing workflow instance or it does not. If the event identification code does not match an identification code associated with an existing workflow instance, supervisor program 21 examines all of the workflows in workflow library 26 to determine if a new instance of a workflow is to be started in response to this event. For each workflow, supervisor program 21 compares the event type of the external event with the event types that start the phases defined for that workflow as shown at 36. If no such phase is found, then the event is not relevant to any of the workflows and the processing of that event is done.

If, on the other hand, the event type matches a starting event for a phase in a given workflow, supervisor program 21 starts a new instance of that workflow as shown at 37. The identification code of the new workflow instance is set to the event identification code, and the new workflow instance is inserted into list 27. Instances of phases that are started by that event are placed in list 24. In one aspect of the invention, supervisor program 21 stores the event descriptive data associated with the event that started the instance of the workflow with the instance of the workflow. The manner in which this event descriptive data is utilized will be discussed in more detail below. The processing of that event is then complete.

If the external event identification code matches that of an existing workflow instance, supervisor program 21 examines the list of active phases for this workflow instance to determine if any of the active phase instances are terminated by this event as shown at 32. If the phase type of the event matches the phase type in the termination list of a phase instance having an identification code matching the identification code of the phase instance, the phase is terminated. When the instance of the phase is terminated, the instance is removed from list 24. All phase instances that are to be terminated are terminated before the supervisor program moves to the next stage of processing.

Next, the supervisor program determines if any new phase instances for the instance of the workflow in question are to be created as shown at 33. The supervisor program goes through the list of phases that are associated with the workflow instance in question. If the event type of the event matches an event type in the start phase list associated with the phase, a new instance of that phase is started and placed in list 24. In one aspect of the invention, event descriptive data associated with the event that starts an instance of a phase is stored with that instance of the phase. The use of this data will be discussed in more detail below.

It should be noted that the same event that terminated a phase can also start that phase. Since instances of phases are terminated before any instances are created, this aspect of the invention provides a mechanism for looping a phase. For example, in the package delivery example, a phase that corresponds to the package leaving the depot to be delivered to the recipient could loop several times if the delivery fails because the recipient is not available to receive the package.

Next, the supervisor program determines if there are any active phase instances remaining for the workflow instance in question as shown at 34. If active phase instances remain, the instance of the workflow in question is still active, and the processing of the event is complete. If no active phase instances remain, then the workflow instance is terminated as shown at 35. In this case, the workflow instance is removed from list 27.

Each time a phase instance is started or terminated, a record is entered into processing history file 25. The event that caused the starting or termination is also included in the history. The processing history file can then be used by other report generating programs to examine the process as defined in the current workflows and provide statistical information about the process. As noted above, each phase can include event descriptive data. This data is included in the processing history file.

It should be noted that the information needed to define a workflow and the phases included therein does not include any computer code. A workflow is defined solely in terms of lists of events and user created names. In one aspect of the present invention, the workflows are created by a user using user interface 23 shown in FIG. 1 that presents the user with lists of possible events from the event generating system that could start or stop phases. The user interface can include displays, keyboards, and/or pointing devices to simplify the interaction of the user and the data processing system.

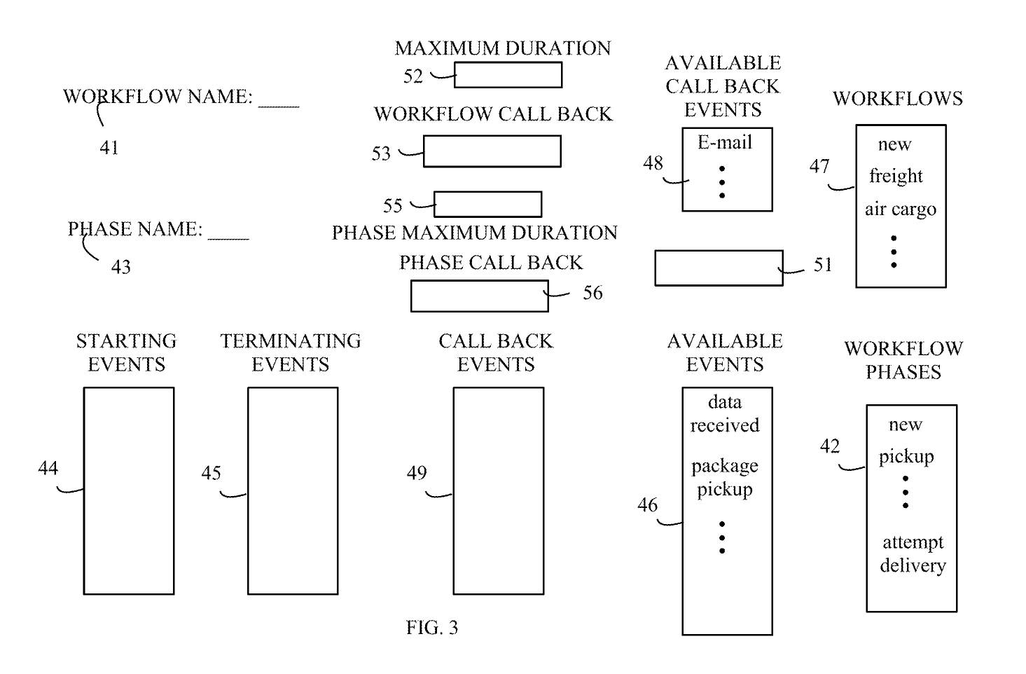

Refer now to FIG. 3, which illustrates a user interface according to one embodiment of the present invention. The user selects a define workflow option from a menu and is presented with the screen display shown in FIG. 3. The user can select an existing workflow to modify or a new workflow by selecting the appropriate item from window 47. If the user selects a “new” workflow, the screen provides the user with a location 41 to assign a workflow name for the workflow that is to be defined. The screen also provides a window 42 that shows the phases for the workflow in question. For a new workflow, window 42 only includes the “new” phase option. When the user selects a new phase, the user is presented with a place 43 to enter a name for the new phase.

In this embodiment, the user is also presented with three windows. Window 44 includes the event types for which an instance of this phase will be started. Similarly, window 45 includes the event types that will terminate the phase. Window 46 displays the available events that are provided by the event generating system and that are available for populating the lists of starting events, stoping events, and call-back events. In one aspect of the invention, the user drags an event from window 46 into window 44 or window 45 to populate the corresponding lists. As will be explained in more detail below, the same event can appear in both windows 44 and 45. When the user has finished defining the events for the current phase, the user can select another phase to define by selecting the “new” phase again. The user can also edit a phase from the current workflow by re-selecting that phase from window 42.

If the user selects an existing workflow from window 47, that workflow's phases are loaded. The user can modify the phases in question and then save the workflow under a new name by changing the name at location 41. If the new name is not in the list of currently defined workflows, the supervisor program saves the workflow as a new workflow and leaves the old workflow unchanged. This aspect of the invention provides a convenient mechanism for defining a workflow that is a variation on a previous workflow without requiring the user to enter all of the phases of the new workflow that correspond to phases of the existing workflow.

As noted above, in one aspect of the present invention, external events include time stamps. The time stamps record the time at which the external event was generated. For example, an event generated by the time a package arrives at a receiving station would include a time stamp indicating the time of arrival. However, the event in question may not enter external event queue 22 until some time later due to delays in the transmission of the information between the point at which the event is generated and the location of data processing system 20.

Ideally, data processing system 20 receives external events in an order that agrees with the time stamps and supervisor program 21 processes those external events in the order specified by the time stamps. In general, workflows assume that certain events will occur in a predetermined order. Hence, errors can occur if that order is not maintained. Unfortunately, external events can be generated by actions at locations that are separated from the location of data processing system 20. In many cases, those events are recorded on a portable recorder that is not read out until some time after the events have been recorded. In the meantime, an event that happened after one of the recorded, but not yet entered events, could be processed by supervisor program 21.

For example, a delivery person may enter an event indicating the delivery of a package at a receiving station on a portable recording device. This generates a “package delivered to facility” event for the corresponding workflow. The time stamp indicates the time the package was handed off to the receiving station. Assume that in the workflow definition, the “package delivered to facility” event terminates a phase and starts another phase “delivery to recipient”. The delivery to recipient phase is terminated by an event, “package delivered to recipient”, indicating that the recipient took possession of the package. If the package delivered to recipient event is processed before the package delivered to facility event is processed due to a delay in the entry of the event, an error will occur, since the phase that was supposed to be terminated by the package delivered to recipient event will not have been started.

To some extent, out-of-order processing can be reduced by utilizing an external event queue in which incoming external events are loaded at locations that maintain the order of the time stamps associated with each event and processing is delayed to compensate for expected delays that could result in out-of-order processing. Such a queue can prevent small out-of-order processing errors at the expense of delaying processing of all of the external events. However, there is a limit to the amount of delay that can be tolerated in the processing.

To avoid errors that would arise from out-of-order processing, supervisor program 21 compares the time stamp on the next external event to be processed with the time stamp of the last external event that was processed. If the time stamp of the last processed event that is stored in processing history file 25 is after that of the current external event, a processing order error has occurred, and supervisor program 21 rolls back the state of the machine to the appropriate point so that the events can be processed in order. Since the phases do not store any internal information that changes over time, all of the information needed to roll back the state of the data processing system is contained in processing history file 25.

As noted above, supervisor program 21 completes the processing of each external event before going on to process the next external event. At any given time, processing history file 25 includes the entire sequence of events that have been processed. In particular, the complete record for each processed event is recorded and the phases that were started or terminated in response to that event are also recorded. Hence, to roll back the data processing system by one event, supervisor program 21 moves the record for the last completed external event back to external event queue 22. Supervisor program 21 then removes any active phases from list 24 that were created in response to that external event. Finally, supervisor program 21 replaces any phases that were removed from list 24 in response to that external event.

This roll back process is repeated, one event at a time until the time stamp on the oldest event in external event queue 22 indicates a time that is after the time shown on the time stamp on the last external event that was recorded in processing history file 25. Supervisor program 21 then proceeds with normal processing by selecting the external event with the oldest time stamp from external event queue 22 and processing that event as described above.

While the above-described embodiments utilize an ordered external event queue, other embodiments could be utilized to provide the roll back feature of the present invention. For example, a simple list of events that are waiting to be processed could be utilized. In such an embodiment, the supervisor would determine the oldest event in the list and process that event next.

In the above-described embodiments, the phase definitions contain only two lists, one for the starting events and one for the terminating events of the phase. This simple structure allows a user to define a workflow and phase without the need to understand a complex underlying event generating system or the need to be competent in some coding or scripting language. All of the statistical processing of the data can be done off-line using the history file and standard database software.

However, in some cases, it is advantageous to provide some additional real-time functions that can be called when some predetermined event is received and a particular phase is active. For example, the designer may wish an email to be sent to some identified party when a particular event is processed and a particular phase is active.

Alternatively, the designer may wish to provide a predicate that must be satisfied before a phase is started or terminated. In this case, the call-back function could signal the supervisor that an event that would normally start an instance of a phase is to be ignored, and the instance should not be started. Similarly, an event that would normally terminate an instance of a phase should be ignored, and the instance should continue to be active. For example, the designer might want to only start or stop a particular phase instance if a specific other phase instance were active when the starting event occurred.

In one aspect of the present invention, such events are handled by providing a list of “call-back” functions that may be triggered by events to provide operations that would otherwise require code to be embedded in the phase definitions. The call-back functions may be applicable to a wide range of businesses or be customized for a particular business model. For example, a call-back function that sends an email is of value in a wide range of business models. Call-back functions that are customized for a particular business are provided with the implementation of the software of the present invention for that business. As will be explained in more detail below, the user who sets up the workflow selects call-back functions that are to be called from within a phase at the time the phase is defined. The call-backs are initiated by the supervisor in response to particular external events for the phase in question.

In one aspect of the invention, the call-back processing software is provided three types of data. As noted above, when an instance of a workflow is started, the event descriptive data associated with the event that started the instance of the workflow is stored. Similarly, when an instance of a phase in that workflow is started, the event descriptive data associated with that event is stored with the instance of the phase. These two types of event descriptive data are sent to the call-back code when a call-back is initiated in response to an external event being processed against an instance of a phase that specifies that the call-back be initiated. In addition, as will be explained in more detail below, there is a third type of data that is specified when a call-back is attached to an event during a phase definition. As will be explained in more detail below, this data is also stored with the phase definition and is also transmitted to the call-back code when the supervisor determines that a call-back is to be initiated. The call-back code also has access to the processing history file, and hence, can determine the state of other instances of phases and workflows that might be needed to provide the particular function associated with the call-back.

In one aspect of the invention, the user who defines the workflow and phases of that workflow choses the call-back functions that are to be attached to a particular external event. In one embodiment, a call-back associated with a phase can be triggered if a predetermined event is received when the instance of the phase is active. This type of call-back is included in a third list in the phase definitions. Referring again to FIG. 3, each entry in the third list 49 includes an event that triggers a call to a specified call-back function, the identity of the call-back function, and any data of the third type discussed above that is to be sent to the call-back function in addition to the above-described event descriptive data associated with the instance of the workflow and the phase. The system of the present invention provides a call-back list 48 of available call-back functions in a manner analogous to the list of possible external events. The user is presented with third list 49 into which the user can drag an event from the external event list and a corresponding call-back function from a call-back list 48. In addition, the user is presented with a call-back data box 51 in which the user can type any data required by that call-back function. The user interface loads call-back data box 51 with an appropriate form corresponding to the particular call-back function.

It should be noted that the call-back list may have multiple entries with the same external event. In this case, different entries would have different call-back functions or the same call-back function, but with different data entries. The features provided by this type of multiple entries can be accomplished with a single more complex call-back function, however, the number of more complex call-back functions would be greater. The multiple entries feature allows a more complex process to be specified from more elementary processes without requiring the intervention of programming personnel with expertise in the underlying computer code. In one aspect of the invention, the call-back functions that are to be executed in response to an event are executed in a predetermined order. For example, the order could be the order of the call-back entries in the third list. This aspect of the invention allows the user to control the order of execution of the call-back functions.

In embodiments that utilize this third call-back list, supervisor program 21 processes the call-back list for an instance of a phase before supervisor program 21 processes the termination list for that instance. When supervisor program 21 processes the existing active phases corresponding to an event, supervisor program 21 first goes through the call-back list and executes any call-back requests that are triggered by that event. Entries are made in processing history file 25 for each call-back function call. This allows an event that terminates a phase to also be an event that executes a call-back function. After the call-back list has been processed, supervisor program 21 then goes through the termination list for that instance to determine if the instance is to be terminated in a manner analogous to that described above for the embodiments that lack a call-back list. Finally, supervisor program 21 determines if any phases are to be started in response to the event. If an instance of a phase is to be started, supervisor program 21 creates the instance in a manner analogous to that discussed above. After creating the instance, supervisor program 21 also processes the call-back list for that instance of the phase. This allows an event that starts an instance of a phase to also be an event that executes a call-back function.

In one embodiment, call-back functions can also be activated when an external event starts or stops an instance of a phase. In this case, the call-back function is attached to the events that start or terminate a phase and result in the same three types of data being sent to the call-back function. In one aspect of the invention, the call-back function can veto the action that the supervisor would normally have taken when processing the external event in question. This aspect of the invention provides a mechanism for conditioning the starting and stopping of an instance of a phase on a predicate that is not known to the supervisor. For example, the user may only wish an instance of a phase to be started in response to a particular event if an instance of a another phase is active. Since the call-back function can view all of the active phase instances as well as the data provided with the call-back function, the call-back function can verify that the predicate is satisfied.

For example, if a call-back function attached to the processing of an event that would terminate an instance of a phase and the event is received, the call-back function would be executed before going on to terminate the instance of the phase. In this case, the call-back function has the option of signaling the supervisor that the instance of the phase is not to be terminated by the event even though the event would normally have terminated the phase. Similarly, if the call-back function is initiated in response to an event that would normally start an instance of a phase, the call-back function can return an argument that prevents the phase instance from actually starting. These veto functions are in addition to the other functions that are provided by the call-back functions.

The call-back functions provide challenges during a roil-back. The history file will include a notation that a call-back was executed. However, the call-back could lead to processing that is not reversible. In one aspect of the invention, each possible call-back function has an “inverse call-back function”. The calls to the call-back functions are also recorded in processing history file 25. During a roll-back, supervisor program 21 calls the corresponding inverse call-back function when such records are encountered during the roll-back. For example, if the call-back function sends an email, the corresponding inverse call-back function would send an “ignore the previous email” message using the same call-back data.

In another aspect of the invention, workflows and phases can have time limits. The time at which an instance of a workflow or phase starts is included in processing history file 25. In addition, these times can be stored with the relevant entries in the active phases and workflow tables. When the supervisor processes an external event that is consumed by a particular instance of a phase, or at predetermined time intervals, the supervisor compares the time at which the instance of the phase or workflow started with the current time. If a call-back function is associated with the time limit, the call-back function is executed in a manner analogous to that described above. For example, the call-back function might send an email to a person identified in the phase or the event descriptive data that was stored with the workflow instance or phase instance. The call-back function itself or the person receiving the email could insert one or more events into the external event queue in response to the exceeded time limit. For example, the new events could cause the current instance of the phase that generated the call-back to be terminated and a new instance of a phase related to the workflow to be started, the new instance would be directed to dealing with the failed time limit.

Refer again to FIG. 3. The specific call-back function associated with a time limit can be entered in box 52 or box 55 in the definition screen. The associated call-backs can be specified by dragging a call-back function from the list of available call-back lists 48 to box 53 or box 56 depending on the time limit in question. However, other methods of specifying the call-back functions could be utilized.

In the above-described embodiments, the instances of workflows are treated as being independent of one another. The workflow instances and the phase instances associated therewith are specified by an identification number and processed by that identification number. In essence, two workflow instances having different identification numbers do not interact. Furthermore, an external event that is to be processed is tied to only one identification number. However, there are cases in which an event that is relevant to one workflow is also relevant to another workflow. In the above-described embodiments, the event is only processed against one of the worflows.

In another aspect of the invention, external events are examined prior to being processed to allow the event to be processed to be matched against related workflows. Refer again to FIG. 1. In this aspect of the invention, an external event is first processed by a related workflows processing module 29, which then generates the external event or events that are processed by supervisor program 21. Related workflows processing module 29 includes lists of related instances of workflows. Each list includes the identification codes for the workflows that are related to each other. If a workflow appears in a list of related workflows, the event in question is duplicated with the identification codes associated with the related workflows so that the event appears to have occurred for each of the related workflow instances. Hence, supervisor program 21 will process that event against the phase instances related to all of the related workflows.

In another aspect of the invention, related workflows processing module 29 also translates identification codes. In some cases, the identification codes used by the event generating system are in a different format and/or numbering scheme than those used in defining the phases of those utilized by the present invention. Related workflows processing module 29 provides a convienent location for making the translation in question.

The manner in which the related workflow instances are defined will, in general, depend on the specific business being modeled in the system. In some cases, an instance of a workflow is created when an individual enters data attaching the identification code assigned to that instance into a database. In such cases, the individual can also enter the related cases that are to be monitored. That information can be included in the tables that contain the lists of related workflow instances.

The above-described embodiments of the present invention utilize a user interface for defining workflow definitions that is part of the data processing system that processes the received conforming events. However, embodiments in which the user interface is run on a separate workstation that provides an output that can be included in the workflow definition library can also be constructed. The output of the workstation then becomes one of the inputs to the data processing system that processes the conforming events.

The present invention also includes a computer readable medium that stores instructions that cause a data processing system to execute the method of the present invention. A computer readable medium is defined to be any medium that constitutes patentable subject matter under 35 U.S.C. 101 and excludes any medium that does not constitute patentable subject matter under 35 U.S.C. 101. Examples of such media include non-transitory media such as computer memory devices that store information in a format that is readable by a computer or data processing system.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

What is claimed is:

1. A method of operating a data processing system to monitor conforming events generated by an event generating system, said method comprising:
storing a list of workflow definitions, each workflow definition comprising a plurality of phase definitions, each phase definition comprising a list of event types that start and terminate that phase;
storing a list of active workflow instances, each active workflow instance conforming to one of said workflow definitions and comprising a list of active phase instances for that active workflow instance; and
for each conforming event received by said data processing system, causing said data processing system to process said conforming event, said processing comprising:
terminating an active phase instance if said conforming event if said conforming event corresponds to an event that terminates that active phase instance;
starting a new active phase instance if said conforming event corresponds to an event that starts a phase corresponding to one of said workflow instances; and
recording said conforming event and all active phase instances that were started or terminated by said conforming event.

2. The method of claim 1 further comprising causing said data processing system to terminate an active workflow instance if no active phase instance corresponds to said active workflow instance after any active phase instance of said active workflow instance has been started in response to said conforming event and to record said termination of said active workflow instance.

3. The method of claim 1 further comprising causing said data processing system to start an active workflow instance corresponding to one of said workflow definitions if no active workflow instance corresponds to said conforming event and said conforming event has an event type that is included in one of said lists of event types that starts a phase of that workflow definition.

4. The method of claim 1 wherein said conforming events are characterized by a time stamp associated with each conforming event, said time stamp defining a time corresponding to said conforming event, said time stamps including an oldest time stamp, and wherein said data processing system further comprises an event queue into which each conforming event is placed prior to being processed, said oldest queue conforming event being said conforming event in said event queue with said oldest time stamp, said data processing system selecting said oldest queue conforming event for processing before others of said conforming events in said event queue.

5. The method of claim 4 wherein said conforming events that were recorded are characterized by an oldest recorded conforming event, said oldest recorded conforming event having a time stamp that is older than all other conforming events that were recorded, and wherein said data processing system compares said time stamp on said oldest queue conforming event to said time stamp of said oldest recorded conforming event, said data processing system moving said oldest recorded conforming event back to said event queue if said time stamp of said oldest recorded conforming event is later than said time stamp of said oldest queue conforming event.

6. The method of claim 5 wherein any active phase instances that were terminated in response to said oldest queue conforming event are moved to said list of active phase instances and wherein any active phase instances that were started in response to said oldest queue conforming event are removed from said list of active phase instances when said oldest recorded conforming event is moved back to said event queue.

7. The method of claim 6 wherein any active workflow instances that were terminated in response to said oldest queue conforming event are moved to said list of active workflow instances and wherein any active workflow instances that were started in response to said oldest queue conforming event are removed from said list of active workflow instances when said oldest recorded conforming event is moved back to said event queue.

8. The method of claim 1 wherein one of said plurality of phase definitions comprises a list of call-back conforming events, each call-back conforming event comprising an event type and a corresponding call-back function to be called if that event type is included in one of said conforming events, said data processing system calling said call-back function prior to terminating any active phase instances associated with said conforming event.

9. The method of claim 1 wherein said data processing system further comprises a user interface that allows a user to define one of said workflow definitions and phases corresponding thereto, said user interface comprising a list of possible conforming events that can be included in said list of event types that start and/or terminate a phase in said workflow definition.

10. The method of claim 9 wherein said user interface allows said user to name each workflow and phase with a name chosen by said user.

11. The method of claim 1 wherein one of said workflow definitions comprises a maximum duration for an instance of that workflow and wherein said data processing system executes a call-back function corresponding to an instance of that workflow definition if said instance of that workflow has been active for longer than said maximum duration.

12. The method of claim 1 wherein one of said phase definitions comprises a maximum duration for an instance of that phase and wherein said data processing system executes a call-back function corresponding to an instance of that phase if said instance of that phase instance has been active for longer than said maximum duration.

13. The method of Claim I wherein said data processing system maintains a list of related workflow instances and wherein said data processing system, in response to said data processing system receiving a conforming event having an identification code that is in said list of related workflow instances, said data processing system generates a new conforming event corresponding to one of said related workflow instances, said new conforming event having an identification code corresponding to another of said related workflow instances, said new conforming event being processed in the same manner as said conforming event.

14. A method for operating a data processing system having a display to allow a user to define workflow definitions having phases corresponding to conforming events generated by an event generating system, said method comprising:
providing a screen display that allows said user to define a name for a workflow definition;
providing a screen display that allows said user to define one or more phases to be included in said workflow definition, said user assigning a user generated name to one of said phases; and
providing a list of conforming event types that can be used to start and/or terminate one of said phases, said user selecting one or more conforming event types to populate a list of events that starts said one of said phases and selecting one or more conforming event types to populate a list of events that terminate said one of said phases.

15. A computer readable medium comprising instructions that cause a data processing system to execute a method for operating a display screen that is part of said data processing system, said method comprising:
storing a list of workflow definitions, each workflow definition comprising a plurality of phase definitions, each phase definition comprising a list of event types that start and terminate that phase;
storing a list of active workflow instances, each active workflow instance conforming to one of said workflow definitions and comprising a list of active phase instances for that active workflow instance; and
for each conforming event received by said data processing system, causing said data processing system to process said conforming event, said processing comprising:
terminating an active phase instance if said conforming event if said conforming event corresponds to an event that terminates that active phase instance;
starting a new active phase instance if said conforming event corresponds to an event that starts a phase corresponding to one of said workflow instances; and
recording said conforming event and all active phase instances that were started or terminated by said conforming event.

16. The computer readable medium of claim 15 wherein said method further comprises causing said data processing system to terminate an active workflow instance if no active phase instance corresponds to said active workflow instance after any active phase instance of said workflow has been started in response to said conforming event and to record said termination of said active workflow instance.

17. The computer readable medium of claim 15 wherein said method further comprises causing said data processing system to start an active workflow instance corresponding to one of said workflow definitions if no active workflow instance corresponds to said conforming event and said conforming event has an event type that is included in one of said lists of event types that starts a phase of that workflow definition.

18. The computer readable medium of claim 15 wherein said conforming events are characterized by a time stamp associated with each conforming event, said time stamp defining a time corresponding to said conforming event, and wherein said data processing system further comprises an event queue into which each conforming event is placed prior to being processed, said conforming events in said queue comprising an oldest queue conforming event, said oldest queue conforming event being said conforming event in said queue with the oldest time stamp, said data processing system selecting said oldest queue conforming event for processing before others of said conforming events in said event queue.

19. The computer readable medium of claim 15 wherein one of said phase definitions comprises a list of call-back conforming events, each call-back conforming event comprising an event type and a corresponding call-back function to be called if that event type is included in one of said conforming events, said data processing system calling said call-back function prior to terminating any active phase instances associated with said conforming event.

20. The computer readable medium of claim 15 wherein said data processing system maintains a list of related workflow instances and wherein said data processing system, in response to said data processing system receiving a conforming event having an identification code that is in said list of related workflow instances, said data processing system generates a new conforming event corresponding to one of said related workflow instances, said new conforming event having an identification code corresponding to another of said related workflow instances, said new conforming event being processed in the same manner as said conforming event that was received by said data processing system.
